(19) United States
(12) Patent Application Publication
(10) Pub. No.: US 2009/0308884 A1
(43) Pub. Date: Dec. 17, 2009

(54) Method and Apparatus for Dispensing Treats

(76) Inventors: Daniel P. Coughlin, Wyckoff, NJ (US); Mary C. Coughlin, Wyckoff, NJ (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/137,102

(22) Filed: Jun. 11, 2008

(51) Int. Cl. G07F 11/00; B65H 3/00; G07F 11/42

(52) U.S. Cl. 221/15; 221/265; 221/258; 221/1

(57) ABSTRACT

A dispensing device that can store a plurality of treats and sequentially release a singe treat is provided. The dispensing device includes a housing and a reservoir in the housing for holding treats to be dispensed. A dispenser is moveable from a first position to a second position to sequentially release treats from the reservoir. An actuating mechanism is provided for actuating the dispenser. The dispensing device also includes a receptacle that is accessible from the exterior of the housing. A passageway is provided for treats to travel from the reservoir to the receptacle.

### FIELD OF THE INVENTION

The present invention relates to a method and apparatus for dispensing a single treat at a time, and more particularly, to a method and apparatus for dispensing treats which requires an extended period of time between each dispensation.

### BACKGROUND OF THE INVENTION

On Halloween it is customary for children to dress up in costumes and go door to door to receive treats such as candy. This is commonly known as trick-or-treating. Presently, it has become popular for parents to accompany their children and chaperone them. However, when the parents and children trick-or-treat, their own house is unattended and children that trick-or-treat at that house will be disappointed because they will not receive treats. One way of handling this is to leave a container of treats on the doorstep of the unattended house. However, this practice is undesirable for various reasons. Namely, a child may take numerous treats from the container, thereby depleting the amount of treats remaining in the container for other children. Another problem is that this practice poses a potential safety risk if someone were to adulterate the treats in the container.

Accordingly, it would be desirable to provide a dispensing device which dispenses a single treat at a time and which requires a period of time between each dispensation to discourage a child from taking more than one treat. It would also be desirable to provide a dispensing device that could be used to dispense treats at times other than Halloween.

### SUMMARY OF THE INVENTION

The present invention relates to a dispensing device that dispenses a single treat at a time and which requires an extended period of time between each dispensation. More particularly, the dispensing device includes a housing and a reservoir in the housing for holding treats to be dispensed. A dispenser is moveable from a first position to a second position to sequentially release treats from the reservoir. An actuating mechanism is provided for actuating the dispenser to move the dispenser incrementally from the first position to the second position. The dispensing device also includes a receptacle that is accessible from the exterior of the housing. A passageway is provided for treats to travel from the reservoir to the receptacle.

A method is also disclosed for providing treats at an unattended location. A device is initially mounted to a supporting surface. The device is allowed to be actuated by an user. A period of time is imposed prior to dispensing.

### BRIEF DESCRIPTION OF THE DRAWINGS

For a more complete understanding of the present invention, reference is made to the following Detailed Description of the Invention, considered in conjunction with the accompanying drawings, in which:

FIG. 1 is a perspective view of a dispensing device according to the present invention;

FIG. 2 is a front view of the dispensing device, which shows a treat loaded in a dispenser;

FIG. 3 is a front view similar to the view shown in FIG. 2, where the dispenser has rotated, causing one of the treats to be released from the dispenser while blocking another treat from entering the dispenser;

FIG. 4 is a cross-sectional view of a portion of an actuating mechanism for actuating the dispenser;

FIG. 5 is a cross-sectional view similar to the view shown in FIG. 4, which shows the portion of the actuating mechanism in an activated position;

FIG. 6 is a rear view of a portion of the actuating mechanism;

FIG. 7 is a rear view of a portion of the actuating mechanism showing a lever arm pivoted upwardly;

FIG. 8 is rear view similar to the view shown in FIG. 7, showing the lever arm pivoted downwardly;

FIG. 9 is a cross-sectional view, taken along section lines 9-9 and looking in the direction of the arrows, of the dispensing device shown in FIG. 2;

FIG. 10 is a perspective view showing another embodiment of the present invention, wherein an actuating mechanism is a rotatable knob;

FIG. 11 is a front view of the dispensing device shown in FIG. 10;

FIG. 12 is a cross-sectional view of a portion of an actuating mechanism of the dispensing device shown in FIG. 10;

FIG. 13 is a front view showing another embodiment of the present invention, wherein electronic control is provided;

FIG. 14 is a front view showing an another embodiment of the present invention, wherein a dispenser is preloaded with treats; and

FIG. 15 is a front view showing another embodiment of the present invention, wherein a dispenser is a L-shaped member.

### DETAILED DESCRIPTION OF THE INVENTION

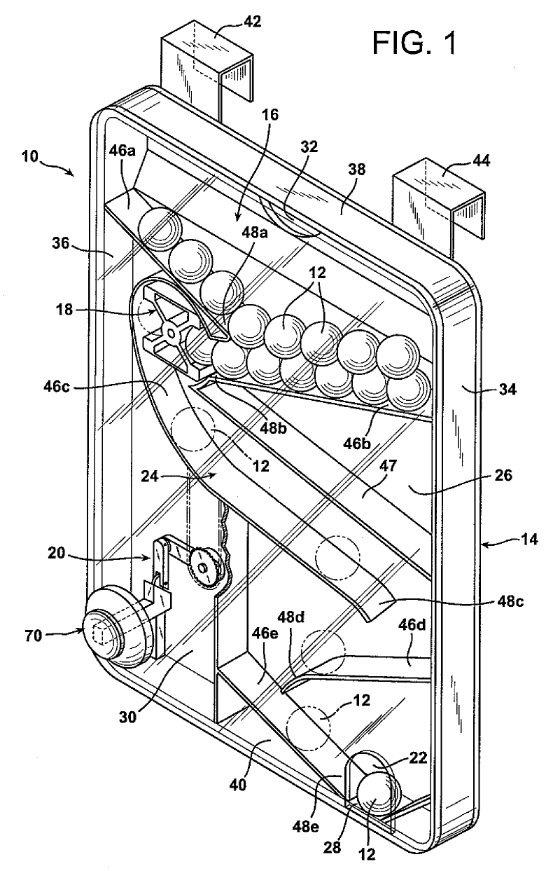

The present invention is described in connection with FIGS. 1-9 which shows a dispensing device adapted to hold a plurality of items, articles, or treats (e.g., spherical containers of candy or any other desirable object such as a trinket or a useful product, generally spherically shaped candy, etc.) and to dispense a single treat or article at a time. The present invention has particular use during Halloween, but it should be understood, that it could also be used during other holidays, other occasions or at any other desirable time. Also, it should be understood that the present invention can be used with other types of items or articles (e.g., Christmas ball ornaments). The invention could even be used as part of a behavioral program, such as, for example, an ABA (Applied Behavioral Analysis) program, where rewards are given for encouraging behavior.

FIG. 1 illustrates a dispensing device 10 that is used to dispense a plurality of treats 12, such as balls containing candy. The dispensing device 10 includes a housing 14 which contains a reservoir 16 for holding the treats 12 to be dispensed, a dispenser 18 for sequentially releasing the treats 12 from the reservoir 16, an actuating mechanism 20 for actuating the dispenser 18, a receptacle 22 accessible from the exterior of the housing 14, and a passageway 24 for the treats 12 to travel from the reservoir 16 to the receptacle 22.

Referring to FIGS. 1-3, the housing 14 includes a front wall 26 that has an opening 28 to provide access to the receptacle 22, a rear wall 30 that has an opening 32 to provide access to the reservoir 16, side walls 34, 36 connecting the front wall 26 to the rear wall 30, a top wall 38 interconnected with the side walls 34, 36, and a bottom wall 40 interconnected with the side walls 34, 36. The front, rear, side, top and bottom walls form a generally rectangular structure. The various walls can be attached together during the manufacturing process, as is known, depending on the materials used, or two or more of the walls can be formed integrally together.

The dispensing device 10 can be configured to be attached to a suitable surface for use. Accordingly, a pair of hooks 42, 44 could be provided extending from the top of the rear wall 30 and sized to removeably secure the dispensing device 10 to a supporting surface (not shown), such as an outer surface of a front door of a house. As such, the hooks 42, 44 would extend over the top of the door and effectively lock the dispensing device 10 to the door when the door is closed and locked. Additionally, when attached and locked to a door, the reservoir opening 32, which will be hereinafter discussed, is inaccessible and the device cannot be ransacked for treats.

It is desirable that the front wall 26 is made at least partially of a transparent material, such as a transparent plastic, such that the interior of the housing 14, or a portion thereof, is visible to an user or observer. This feature may be advantageous for entertainment purposes, since the contents of the dispensing device 10 may attract interest. Of course, the housing 14 could be made from opaque material if the visibility of its contents is not desired. The housing 14 can be decorated with indicia, pictures, symbols, etc., and can accordingly be designed for use at a specific time of the year or holiday such as Halloween, or any other time of year or holiday. The decorations can be manufactured as part of the dispensing device 10, or the dispensing device 10 can be decorated, and even redecorated by an user. Indeed, the dispensing device 10 could come with a decorating kit so that it could be decorated by the purchaser. Such a kit could include a coloring applicator, such as markets, adhesive, figures, etc.

The treats 12 to be dispensed are placed in the reservoir 16 via the reservoir opening 32 formed in the rear wall 30. The opening 32 allows the dispensing device 10 to be refillable. Of course, the device could be manufactured as a single use, disposable device pre-loaded with treats. On the other hand, the reservoir opening 32 could be positioned at any other desirable location, such as on the top wall 38, and it could include a cover if desired, which cover could be a locking cover, if desired.

The dispenser 18 sequentially releases the treats 12 from the reservoir 16 to a portion of the passageway 24 positioned below the dispenser 18. The dispenser 18 will be discussed in further detail after discussion of the passageway 24.

The passageway 24 descends toward the receptacle 22 and is configured such that the treats 12 arrive at the receptacle 22 after an extended period of time for reasons to be discussed hereinafter. The passageway 24 could be in form or an elaborate winding path, or panels positioned at angles directing the treat 12 to the receptacle 22, or it could be a short drop to the receptacle 22, or any other suitable configuration. As shown in the FIGS. 1-3, the passageway 24 includes a plurality of panels 46a-e, each of which inclines downwardly toward the receptacle 22. Each of the panels 46a-e has a bottom end 48a-e. The panels 46a-e are vertically spaced relative to each other to allow the treats 12 to travel from one panel to an adjacent lower panel.

The first panel 46a and the second panel 46b are provided in the reservoir 16 and are adjacent to each other such that any treat 12 falling from the first panel 46a will land on the second panel 46b. The bottom end 48b of the second panel 46b is adjacent to the dispenser 18 such that the bottommost treat 12 on the second panel 46b can enter the dispenser 18 when the dispenser 18 is properly aligned, as will be discussed. The third panel 46c cooperates with the dispenser 18 such that any treat 12 released from the dispenser 18 will land on the third panel 46c. The third panel 46c could be continuous with the first panel 46a. The third panel 46c terminates above and adjacent to the fourth panel 46d such that any treat 12 falling from the third panel 46c will land on the fourth panel 46d. Likewise, the fourth panel 46d is above and adjacent to the fifth panel 46e such that any treat 12 falling from the fourth panel 46d will land on the fifth panel 46e. The bottom end 48e of the fifth panel 46e is positioned adjacent to the receptacle 22 such that any treat 12 traveling on the fifth panel 46e will land in the receptacle 22. A panel 47 is attached to the second panel 46b and is continuous with the second panel 46b. The panel 47 serves to support the second panel 46b.

The configuration of the passageway 24 as shown in the figures and discussed herein is only exemplary, and it will be apparent that the present invention can employ other configurations for delivering a treat to a receptacle. Some such configurations may include passageways or chutes for the treats 12 to travel from the reservoir 16 to the receptacle 22, or the treats can otherwise be delivered to the receptacle, by for example, a rotating dispensing device that moves the treats past a receptacle where the treats can be removed from the rotating dispenser.

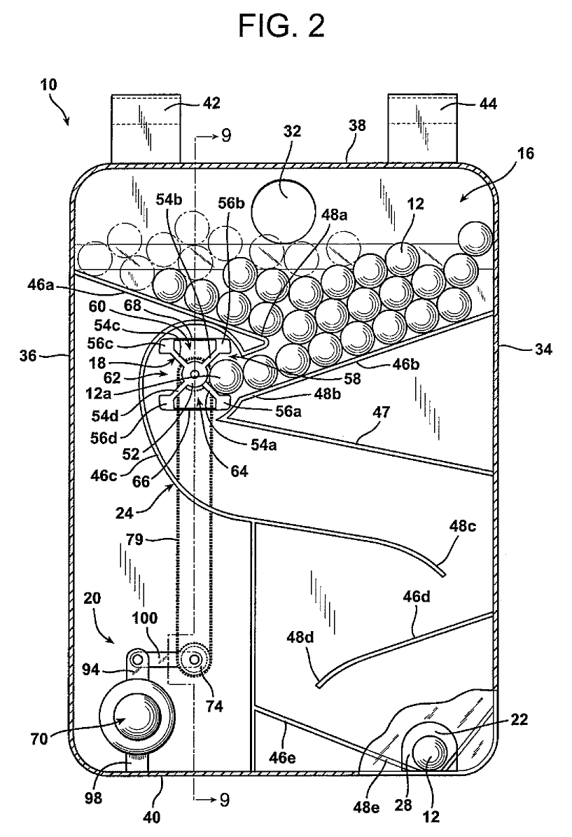

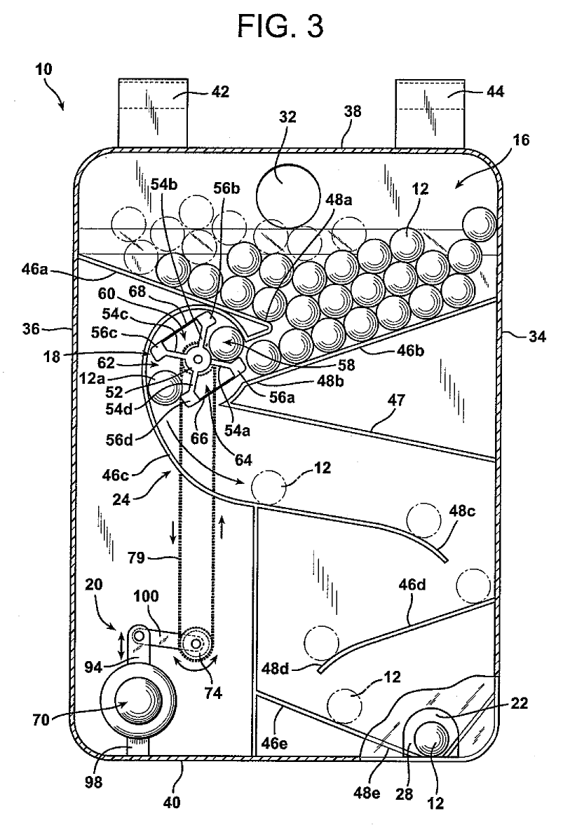

As will be explained in further detail hereinafter, the dispenser 18 is driven by the actuating mechanism 20. More particularly, the dispenser 18 shown in the figures is adapted to rotate when actuated. Referring to FIGS. 2 and 3, the dispenser 18 includes a central portion 52 and a plurality of arms 54a-d extending radially outwardly from the central portion 52. Each of the arms 54a-d includes a free end 56a-d. An opening 58 is formed between an adjacent pair of arms 54a-b, while an opening 60 is formed between an adjacent pair of arms 54b-c. Likewise, an opening 62 is formed between an adjacent pair of arms 54c-d, while an opening 64 is formed between an adjacent pair of arms 54d-a.

The opening 58 formed between the arm 54a and the arm 54b is unobstructed and is sized to accommodate only a single treat 12. The opening 58 allows the treat 12 to fall from the dispenser 18. Also, the opening 62 formed between the arm 54c and the arm 54d is unobstructed and is sized to accommodate only a single treat 12. The opening 62 allows the treat 12 to fall from the dispenser 18. A board 66 connects the free end 56a of the arm 54a to the free end 56d of the arm 54d so as to block access to the opening 64 thereby closing the opening 64, and a board 68 connects the free end 54b of the arm 56b to the free end 56c of the arm 54c so as to block access to the opening 60 thereby closing the opening 60. The purpose of the boards 66, 68 is to increase time between each dispensation. Any of the openings 58, 60, 62, and 64 could be open or closed to adjust the rate of dispensation.

Referring to FIG. 2, a treat 12a can be loaded into the dispenser 18 when the opening 58 (as shown in FIG. 2) or 62 is substantially adjacent to the treat 12 positioned at the bottom end 48b of the second panel 46b. Because the second panel 46b is inclined downwardly, the treat 12 moves into the dispenser 18 when the opening 58 or 62 is aligned with the treat 12.

As the dispenser 18 rotates to a position shown in FIG. 3, the free end 56a of the arm 54a prevents further treats 12 from being accepted into the dispenser 18. As the dispenser 18 continues to rotate, the treat 12 falls from the opening 62 onto the third panel 46c when the free end 56d of the arm 54d is substantially facing the bottom wall 40. In this manner, the treats 12 can be sequentially released from the dispenser 18. As shown in FIG. 3, the dispenser 18 can accommodate up to two treats 12a, 12b at a time.

The configuration of the dispenser 18 is only exemplary. It will be understood that the present invention can employ other dispensers or transfer devices to transfer the treats 12 from the reservoir 16 to the third panel 46c. For example, the dispenser 18 could be a large rotating structure with a plurality of receptacles for treats. The time involved in rotating the structure to move treats to a dispensing point could provide the period needed to discourage an user from taking more than one treat. Alternatively, any other sequential dispensing mechanism could be employed in furtherance of the spirit and scope of the present invention.

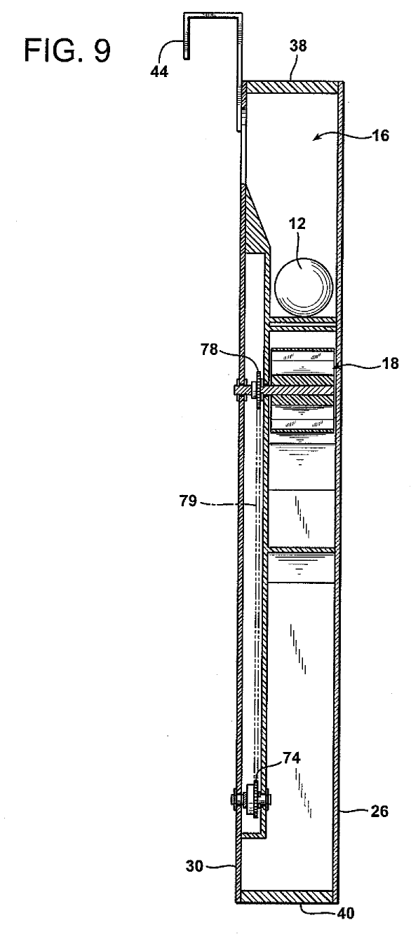

The actuating mechanism 20 includes a button 70, a linkage assembly 72, a lower sprocket 74, a ratchet assembly 76 attached to the lower sprocket 74; an upper sprocket 78 (see FIG. 9) attached to the dispenser 18, and a chain 79 trained around the lower sprocket 74 and the upper sprocket 78.

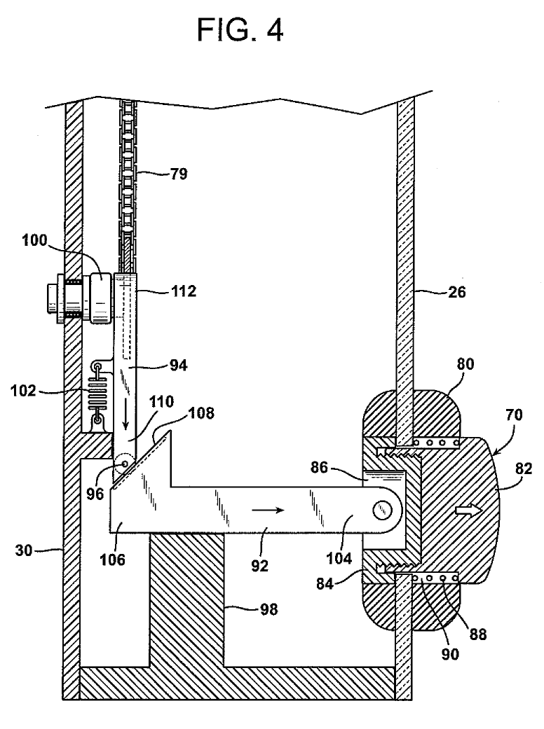

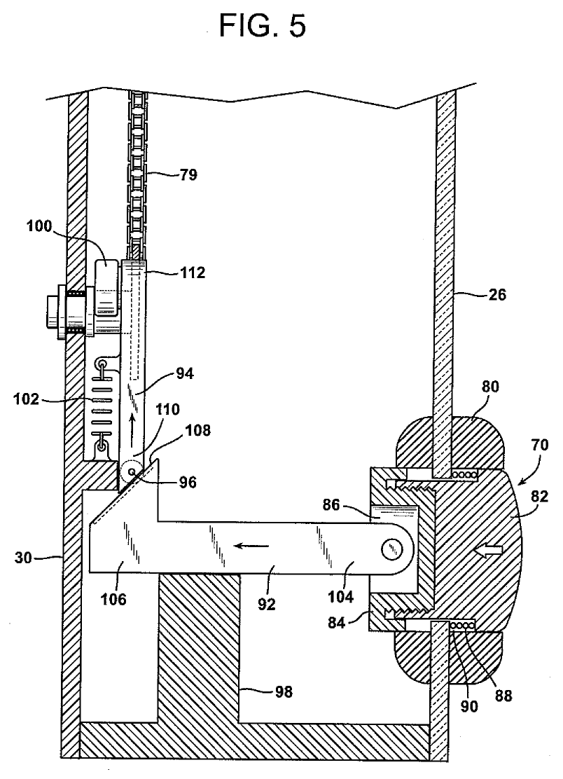

Referring to FIGS. 4 and 5, the button 70 includes a base 80 mounted to the front wall 26, a front portion 82, a rear portion 84 connected to the front portion 82, an opening 86 formed in the rear portion 84, a spring 88 positioned in a cavity 90 formed between the base 80 and the front portion 82. The button 70 is sized to move between an inner retracted position as shown in FIG. 5 when the front portion 82 is depressed by an user and an outer extended position as shown in FIG. 4. The spring 88 is sized to axially urge the button 70 to its outer extended position as shown in FIG. 4.

With reference to FIGS. 4-6, the linkage assembly 72 includes a horizontal driving arm 92 attached to the button 70 that drives a vertical driven arm 94. More particularly, a proximal end 104 of the horizontal driving arm 92 is attached to the rear portion 84 of the button 70 such that the horizontal driving arm 92 is movable conjointly with the button 70. A distal end 106 of the horizontal driving arm 92 is positioned adjacent to the rear wall 30 of the housing 14. The distal end 106 of the horizontal driving arm 92 includes a ramp mechanism, such as an inclined surface 108, to allow a wheel 96 of the vertical driven arm 94 to slide therealong. The horizontal driving arm 92 is adapted to move toward the rear wall 30 of the housing 14 when the button 70 is depressed as shown in FIG. 5. This motion causes the wheel 96 to slide in an upward direction along the inclined surface 108. A fulcrum 98 is sized to support the horizontal driving arm 92.

Referring to FIGS. 4 and 5, a proximal end 110 of the vertical driven arm 94 includes the wheel 96 which cooperates with the inclined surface 108, while a distal end 112 of the vertical driven arm 94 is attached to a lever arm 100 and is pivotable thereabout. The vertical driven arm 94 is adapted to move between a lower position as shown in FIG. 4, wherein the wheel 96 is positioned on the bottom of the inclined surface 108, and an upper position as shown in FIG. 5, wherein the wheel 96 is positioned on the top of the inclined surface 108. When the button 70 is released, a spring 102 urges the vertical driven arm 94 to its lower position as shown in FIG. 4 and the horizontal driving arm 92 moves toward the front wall 26 of the housing 14.

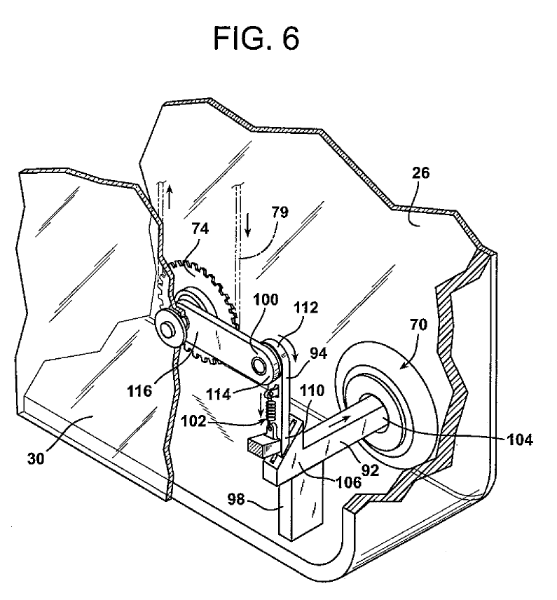

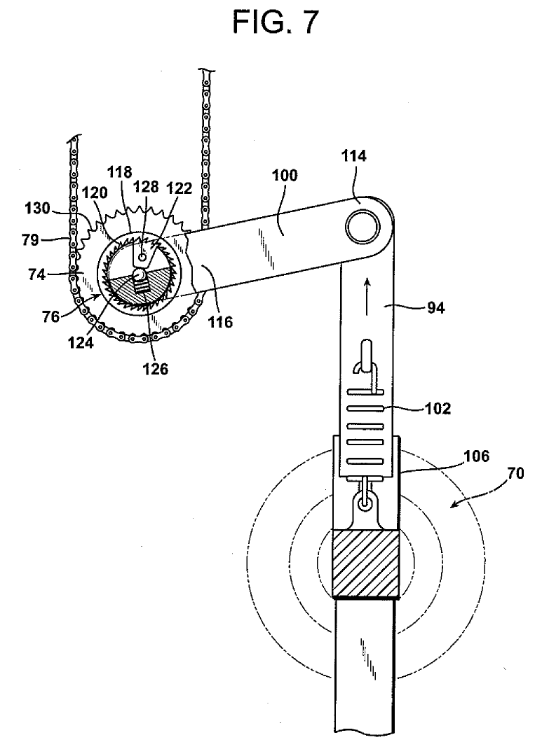

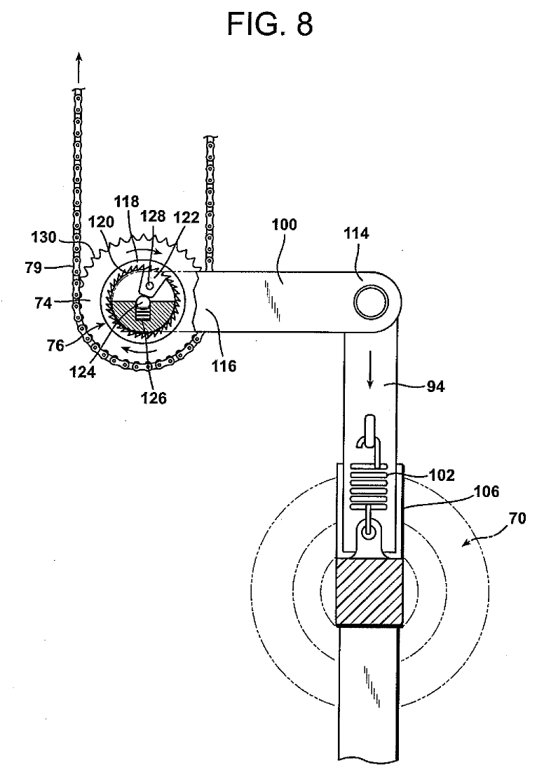

With reference to FIG. 6, the lever arm 100 has a proximal end 114 attached to the vertical driven arm 94 and a distal end 116 attached to the ratchet assembly 76. The proximal end 114 of the lever arm 100 pivots upwardly as the vertical driven arm 94 moves to its upper position as shown in FIG. 7, and pivots downwardly as the vertical driven arm 94 moves to its lower position as shown in FIG. 8.

Referring to FIGS. 7 and 8, the ratchet assembly 76 includes a ratchet housing 118 having a plurality of teeth 120, a pawl 122 sized to engage the teeth 120, a steel ball 124 in slidable contact with the pawl 122, a spring 126 urging the steel ball 124 against the pawl 122, and a pin 128 extending through the pawl 122 and the distal end 116 of the lever arm 100, which attaches the pawl 122 to the lever arm 100. Referring to FIG. 7, the pawl 122 and the ratchet housing 118 cooperate such that when the lever arm 100 is pivotably moved upwardly, the pawl 122 catches the teeth 120, thereby preventing movement of the ratchet housing 118. When the lever arm 100 is pivotably moved downwardly as shown in FIG. 8, the pawl 122 slides over the teeth 120, which rotates the ratchet housing 118 in a clockwise manner (when viewed through the rear wall of the housing), thereby advancing the chain 79. Alternatively, the present invention could be configured such that the ratchet housing 118 moves in a counterclockwise manner. Thus, the present invention is not limited by the term “clockwise.”

The lower sprocket 74 is attached to the ratchet housing 118 such that the lower sprocket 74 rotates conjointly with the ratchet housing 118 in a clockwise manner as shown in FIG. 8. The chain 79 connects the lower sprocket 74 to the upper sprocket 78 such that when the lower sprocket 74 rotates in a certain direction, the upper sprocket 78 is caused to rotate in the same direction. The upper sprocket 78 is attached to the dispenser 18 such that the dispenser 18 rotates conjointly with the upper sprocket 78.

The configuration of the actuating mechanism 20 is only exemplary. It will be understood that the present invention can employ other mechanisms to actuate the dispenser 18. For example, the present invention could employ other mechanical structures to actuate the dispenser 18. The present invention could also employ solenoids or other electronic mechanisms to actuate the dispenser 18. The present invention could employ a switch rather than a button.

To operate the dispensing device 10, an user depresses the button 70, thereby moving the horizontal driving arm 92 toward the rear wall 30 of the housing 14 as shown in FIG. 5. The movement of the horizontal driving arm 92 causes the wheel 96 to slide in an upward direction along the inclined surface 108, thereby causing the vertical driven arm 94 to move from its lower position to its upper position. As the vertical driven arm 94 moves to its upper position, the lever arm 100 pivots upwardly as shown in FIG. 7. The pawl 122, in turn, catches the teeth 120 of the ratchet housing 118.

When the user releases the button 70, the horizontal driving arm 92 moves toward the front wall 26 of the housing 14 and the wheel 96 slides in an downward direction along the inclined surface 108 as shown in FIG. 4, thereby causing the vertical driven arm 94 to assume its lower position. As the vertical driven arm 94 moves to its lower position, the lever arm 100 pivots downwardly as shown in FIG. 8. The pawl 122, in turn, slides over the teeth 120, thereby rotating the ratchet housing 118 in a clockwise manner. The ratchet assembly 76 rotates the lower sprocket 74 causing the teeth 130 of the lower sprocket 74 to engage the links of the chain 79 and thereby revolve the chain 79 around the lower sprocket 74 and the upper sprocket 78. The rotation of the upper sprocket 78 causes the dispenser 18 to rotate.

The user repeatedly depresses the button 70 and releases the button 70, which will cause the dispenser 18 to rotate incrementally between various positions. The user continues to depress the button 70 and release the button 70 in order to rotate the dispenser 18 until the treat 12 releases from the dispenser 18 and falls onto the third panel 46c. The treat 12 then travels down the third panel 46c and falls onto the fourth panel 46d. The treat 12 travels down the fourth panel 46d and falls onto the fifth panel 46e. The treat 12 travels down the fifth panel 46e to the receptacle 22. The user accesses the treat 12 through the opening 28 in the front wall 26 when the treat 12 is positioned in the receptacle 22.

If the user attempts to retrieve a second treat 12 from the dispensing device 10, the user will be required for a second time to repeatedly depress the button 70 and release the button 70 to rotate the dispenser 18 until the second treat 12 releases from the dispenser 18. The user will have to repeat the operation each time for any additional treat 12.

The dispensing device 10 is configured such that a single treat 12 is released from the dispenser 18 after an extended period of time since it takes time for an user to repeatedly depress and release the button 70. In view of the number of panels 46a-e, the passageway 24 is configured such that the treat 12 arrives at the opening 32 after an extended period of time. Thus, an extended period of time (e.g., many seconds or even one minute) is required between each dispensation. This extended period of time discourages an user from taking more than one treat 12 because the user would have to wait for another period of time for additional treats. Thus, a time delay is imposed between actuating the dispenser and sequentially releasing treats.

It should be noted that numerous other advantages are provided by the dispensing device 10. For example, the dispensing device 10 can be used at a house during Halloween when the occupants are not at home or otherwise elect not to open their door.

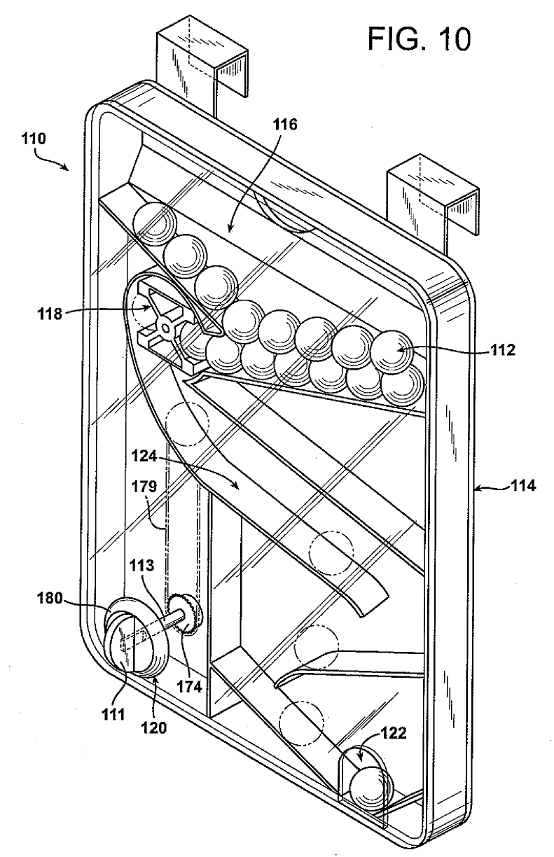

FIGS. 10-12 show another embodiment of a dispensing device of the present invention, indicated generally as 110, that is used to dispense a plurality of treats 112. The dispensing device 110 operates and is constructed in manners consistent with the dispensing device 10 shown in FIGS. 1-9, unless stated otherwise. Like the dispensing device 10, the dispensing device 110 includes a housing 114, a reservoir 116, a dispenser 118, an actuating mechanism 120, a receptacle 122, and a passageway 124.

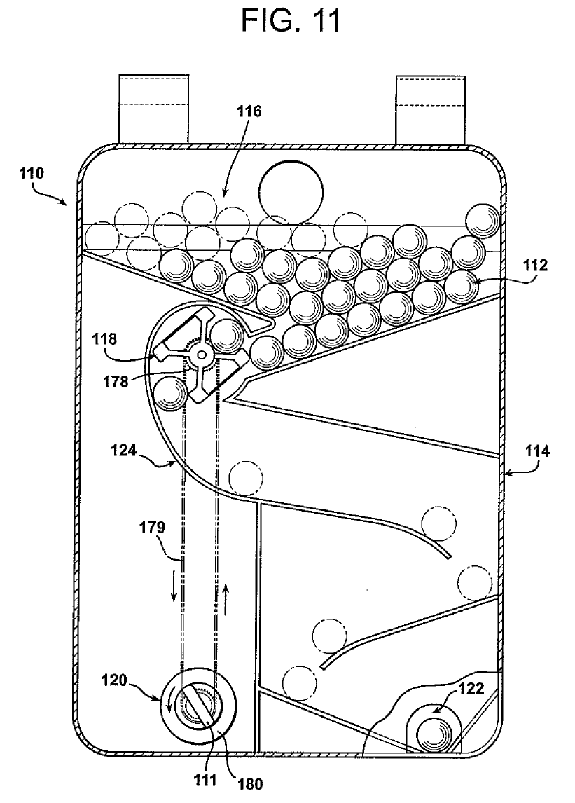

Referring to FIGS. 10-12, the actuating mechanism 120 includes a manually operable knob 111 that is interconnected with a first end of axle 113. The knob 111 rotates the axle 113 when turned, which in turn rotates the lower sprocket 174. The axle 113 is supported at a second end by axle support 115. A chain 179 rides the lower sprocket 174 and extends about the upper sprocket 178 (see FIG. 11).

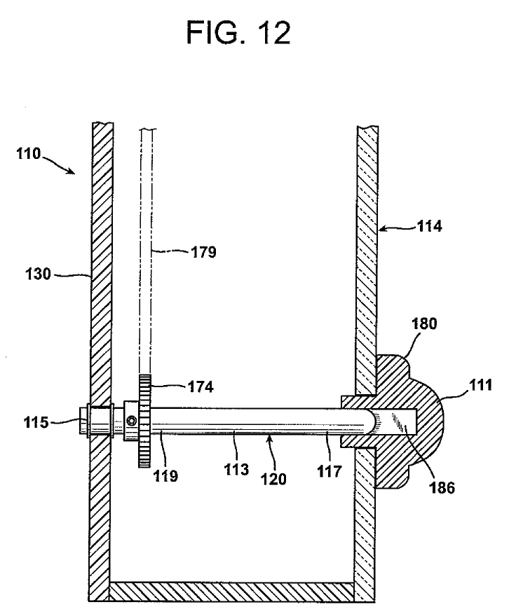

With reference to FIG. 12, a proximal end 117 of the axle 113 is positioned within an opening 186 formed in a base 180 of the knob 111 such that the axle 113 is movable conjointly with the knob 111. A distal end 119 of the axle 113 is attached to the lower sprocket 174 such that rotation of the axle 113 and the knob 111 causes the lower sprocket 174 to rotate. The support 115 extends through a rear wall 130 and is sized and configured to support the axle 113.

To operate the dispensing device 110, an user grips the knob 111 and rotates the knob 111 in a counterclockwise manner, thereby rotating the axle 113 and the lower sprocket 174 in a counterclockwise manner. Rotation of the lower sprocket 174 drives the chain 179 around the lower sprocket 174 and the upper sprocket 178. The rotation of the upper sprocket 178 causes the dispenser 118 to rotate. The gearing of the upper sprocket and lower sprocket can be such that numerous rotations of the knob are required to move the upper sprocket sufficiently to move the dispenser sufficiently to dispense a treat.

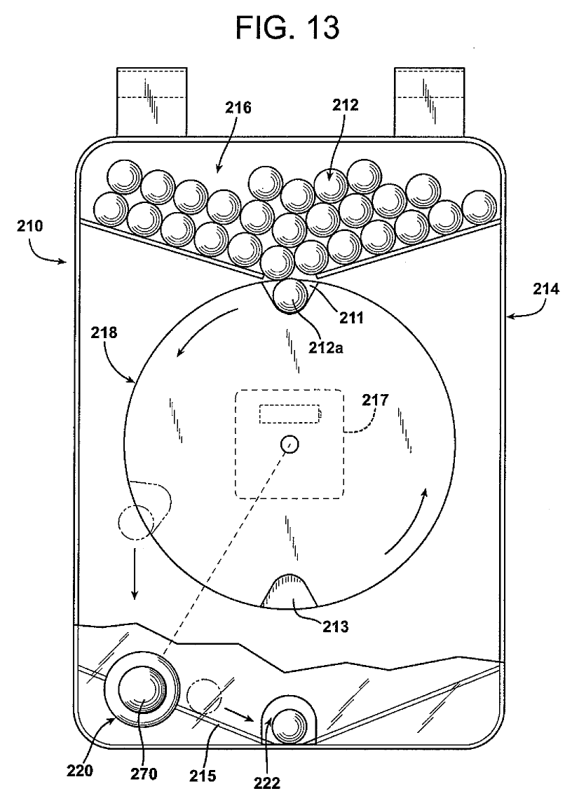

FIG. 13 shows another embodiment of a dispensing device of the present invention, wherein electronic control is provided. The dispensing device 210 operates and is constructed in manners consistent with the dispensing device 10 shown in FIGS. 1-9, unless stated otherwise. The dispensing device 210 includes a housing 214, a reservoir 216, a dispenser 218, an actuating mechanism 220, and a receptacle 222.

The dispenser 218 is a large rotating structure with a pair of openings 211 and 213 that are sized to contain a treat 212. The openings 211 and 213 are diametrically opposed to each other. A treat 212 can be loaded into the dispenser 218 when the opening 211 or 213 is substantially adjacent to the treat 212a positioned at the bottom of the reservoir 216. The treat 212 falls from the opening 211 or 213 when the dispenser 218 is rotated to the position shown in phantom in FIG. 13. A panel 215 is provided for the treats 212 to travel from the dispenser 218 to the receptacle 222.

The actuating mechanism 220 includes a button 270 and a circuit unit 217. The circuit unit 217 includes various conventional electrical/electronic components, such as a circuit board, a motor, and a power source (e.g., a battery). The button 270, the circuit unit 217, and the dispenser 218 are in electrical communication with each other such that when an user depresses the button 270, the dispenser 218 is actuated and rotates a pre-set amount. As such, the button 270 must be depressed multiple times to effect dispensation of a treat 212. Alternatively, a time delay can be programmed such that when an user depresses the button 270 only once, the dispenser 218 is actuated and dispenses a treat 212 after an extended period of time.

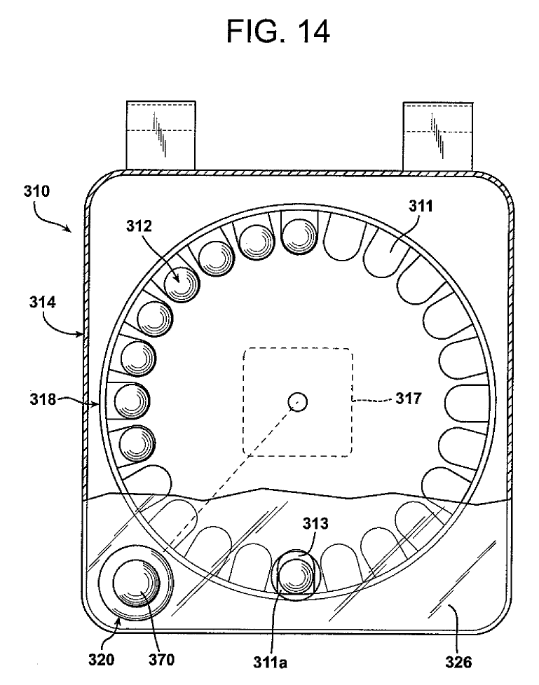

Another embodiment of the present invention is illustrated in FIG. 14. The embodiment of the present invention shown in FIG. 14 operates and is constructed in manners consistent with the foregoing description of the dispensing device 10 shown in FIGS. 1-9, unless stated otherwise.

FIG. 14 shows a dispensing device 310, wherein a dispenser 318 is preloaded with treats 312. Alternatively, the device 310 could include a reservoir of treats and can self-reload as described herein with respect to other embodiments. The dispensing device 310 also includes a housing 314 and an actuating mechanism 320, which includes a button 370 and a circuit unit 317, for actuating the dispenser 318. As with other embodiments of the invention, a delay tactic is employed to consume time from an initial actuation effort to dispensation of a treat. Here, the delay tactic could comprise a time delay in an electronic circuit or the requirement of numerous actuations of an actuator. Alternatively, manual actuation techniques associated with other embodiments of the invention can be employed.

The dispenser 318 is a large rotating structure with a plurality of openings 311 along its perimeter. The openings 311 are sized to contain the treats 312. A cut-out 313 is formed in a front wall 326 to provide access to the bottommost opening 311a of the dispenser 318.

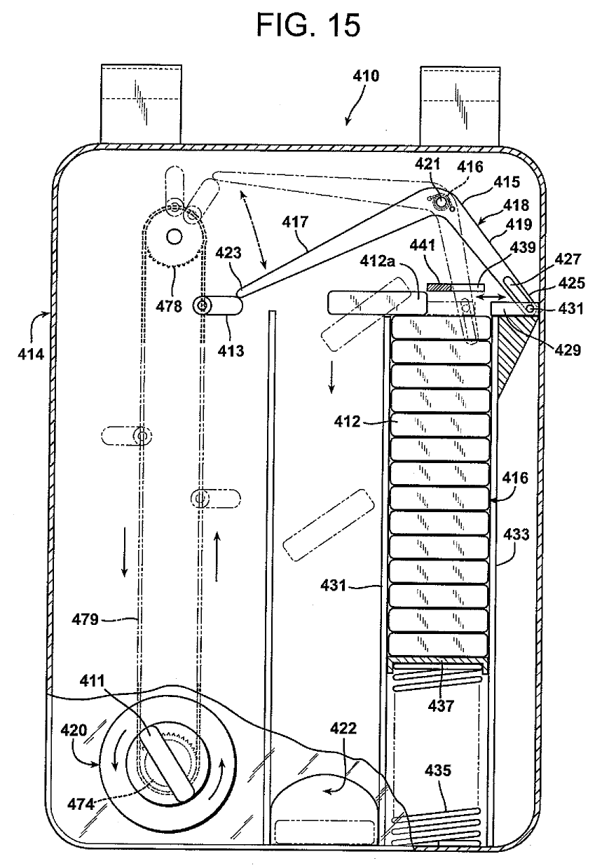

FIG. 15 shows another embodiment of a dispensing device of the present invention. The dispensing device 410 operates and is constructed in manners consistent with the dispensing device 10 shown in FIGS. 1-9, unless stated otherwise. The dispensing device 410 includes a housing 414, a reservoir 416, a dispenser 418, an actuating mechanism 420, and a receptacle 422 positioned between the dispenser 418 and the reservoir 416.

The actuating mechanism 420 operates and is constructed in manners similar to the actuating mechanism 120 (see FIGS. 10-12). The actuating mechanism 420 includes a manually operable knob 411, a lower sprocket 474, a chain 479, and an upper sprocket 478. A projection member 413 is attached to the chain 479 and moves conjointly with the chain 479. The projection member 413 is sized to engage the dispenser 418 for reasons to be discussed hereinafter.

The dispenser 418 is in the form of a L-shaped member 415 with a first arm 417 and a second arm 419. The L-shaped member 415 is sized to move about a pivot area 421. The L-shaped member 415 moves between a relaxed position and an extended position. A spring 416 is provided to urge the L-shaped member 415 to its relaxed position. The first arm 417 includes a distal end 423 sized to engage the projection member 413, and the second arm 419 includes a distal end 425 that has a slot 427. Contact between the first arm 417 and the projection member 413 moves the L-shaped member 415 to its extended position.

A plunger 429 is connected to the distal end 425 of the second arm 417 by a pin 431 received in the slot 427. The pin 431 is sized to slide in the slot 427 as the L-shaped member 415 moves between its relaxed and extended positions. The plunger 429 is movably connected to the L-shaped member 415 such that the plunger 429 moves in a horizontal direction as the L-shaped member 415 moves for reasons to be discussed hereinafter.

The reservoir 416 includes two vertical walls 431, 433, a pair of springs 435, a bottom plate 437 connected to the springs 435, and a top plate 439. The treats 412 are vertically stacked on the bottom plate 437 and between the two walls 431, 433. The springs 435 are connected to the bottom plate 437 and are sized to axially urge the treats 412 upwardly toward the top plate 439.

The top plate 439 is connected to the back wall of the housing 414. The top plate 439 includes an extension member 441 that is connected to the front wall of the housing 414. The top plate 439 is sized to function as a stop and inhibits the treats 412 from moving after the treats 412 come into contact with the top plate 439. The top plate 439 also inhibits the plunger 429 from moving after the second arm 419 of the L-shaped member 415 comes into contact with the top plate 439.

To operate the dispensing device 410, an user grips the knob 411 and rotates the knob 411 in a counterclockwise manner, thereby rotating the chain 479 and the projection member 413. The user continues to rotate the knob 411 until the projection member 413 comes into contact with the first arm 417 of the dispenser 418 and moves the first arm 417 upwardly to thereby pivot the L-shaped member 415 to its extended position. As the first arm 417 moves upwardly, the second arm 419 moves toward the reservoir 416. This motion causes the plunger 429 to move in a horizontal direction, thereby moving the treat 412a horizontally. The plunger 429 continues to move in a horizontal direction until the second arm 419 contacts the top plate 439. The plunger 429 moves the treat 412a such that a sufficient portion of the treat 412a is extended beyond the reservoir 416 so as to allow the treat 412a to tip and fall in a vertical direction toward the receptacle 422 The first arm 417 then moves downwardly due to the spring 416 so as to move the L-shaped member 415 to its relaxed position.

The dispensing device 10, 110, 210, 310, 410 can employ an illumination source (not shown), such as a light bulb or an array of light emitting diodes. The dispensing device 10, 110, 210, 310, 410 can also be configured to emit a sound and/or other special effects upon actuation. The motif of the dispensing device 10, 110, 210, 310, 410 could be changeable.

It will be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A dispensing device comprising:
a housing;
a dispenser within said housing, said dispenser moveable from a first position to a second position to sequentially release treats contained in said housing;
actuating means for actuating said dispenser to move said dispenser incrementally from said first position to said second position;
a time delay imposed between actuating the dispenser and sequentially releasing treats; and
a receptacle for receiving treats released by said dispenser, said receptacle accessible from outside of said housing.

2. The dispensing device of claim 1, further comprising a reservoir positioned in said housing, said reservoir sized to contain treats to be dispensed.

3. The dispensing device of claim 2, further comprising a passageway sized to allow treats to travel from said reservoir in said housing, through said dispenser, and to said receptacle.

4. The dispensing device of claim 3, wherein said passageway includes a plurality of panels, each of said panels being vertically spaced relative to the other of said panels to allow treats to travel from one of said panels to another of said panels.

5. The dispensing device of claim 4, wherein said dispenser includes a central portion and a plurality of arms extending radially outwardly from said central portion, each of said arms being rotatable about a horizontal axis.

6. The dispensing device of claim 5, wherein one or more openings are formed between one or more pairs of said arms, said openings being sized to accommodate a single treat.

7. The dispensing device of claim 6, wherein said dispenser includes second openings between second pairs of arms, said second openings being capable of being blocked by a board.

8. The dispensing device of claim 5, wherein said actuating means includes an upper sprocket attached to said dispenser and moveable conjointly with said dispenser such that said dispenser rotates when said upper sprocket rotates, a lower sprocket, a chain connecting said lower sprocket to said upper sprocket, and driving means for driving said lower sprocket.

9. The dispensing device of claim 8, wherein said driving means includes a ratchet assembly, a button sized to move between a retracted position and an extended position, and a linkage assembly attached to said button and to said ratchet assembly, said linkage assembly being movable conjointly with said button, said ratchet assembly being driven when said button is in its retracted position.

10. The dispensing device of claim 9, wherein said ratchet assembly includes a ratchet housing having a plurality of teeth, a pawl sized to engage said teeth, a ball in slidable contact with said pawl, and a spring urging said ball against said pawl.

11. The dispensing device of claim 10, wherein said ratchet housing is rotatable in a first rotational direction and in a second rotatable direction, said pawl sized to allow movement of said ratchet housing in said first rotational direction when said pawl slides over said teeth, thereby rotating said lower sprocket, and said pawl sized to prevent movement of said ratchet housing in said second rotatable direction.

12. The dispensing device of claim 5, wherein said actuating means includes a device accessible by an user, said device being in electrical communication with a motor for moving said dispenser.

13. The dispensing device of claim 8, wherein said driving means includes a knob sized to rotate, an axle attached to said knob and sized to rotate conjointly with said knob, said axle attached to said lower sprocket and moveable conjointly with said lower sprocket such that said lower sprocket rotates when said axle rotates.

14. The dispensing device of claim 2, wherein said dispenser includes a rotating structure and a first opening formed in said rotating structure, said first opening sized to contain a treat.

15. The dispensing device of claim 14, wherein said rotating structure includes a second opening diametrically opposed to said first opening.

16. The dispensing device of claim 15, wherein said rotating structure is sized to deliver treats from said reservoir in said housing to said receptacle.

17. The dispensing device of claim 16, wherein said actuating means includes a device accessible by an user, said device being in electrical communication with a motor for moving said dispenser.

18. The dispensing device of claim 1, wherein said dispenser includes a rotating structure and a plurality of openings formed in said rotating structure.

19. The dispensing device of claim 18, further comprising a plurality of treats, at least one of said openings including one of said treats.

20. The dispensing device of claim 19, wherein said housing includes a cutout to provide access to said dispenser.

21. The dispensing device of claim 20, wherein said receptacle comprises a portion of said dispenser positioned at an access point.

22. The dispensing device of claim 21, wherein said rotating structure is sized to deliver treats to said portion of said dispenser positioned at said access point.

23. The dispensing device of claim 22, wherein said actuating means includes a device accessible by an user, said device being in electrical communication with said dispenser.

24. A method for providing treats at an unattended location, comprising the steps of:
(a) mounting a device for dispensing treats on a supporting surface;
(b) allowing actuation of the device;
(c) dispensing treats to a receptacle;
(d) imposing a time delay between actuation and dispensation; and
(e) allowing treats to be retrieved from the receptacle.

25. The method of claim 24, further comprising the step of loading treats into a reservoir of the device.

26. The method of claim 24, wherein the step of imposing a time delay comprises requiring numerous manual actuations of the device before allowing treats to be retrieved.

27. The method of claim 24, wherein the step of imposing a time delay comprises providing a passageway for the treats to travel through the device.

28. The method of claim 24, wherein the step of imposing a time delay comprises imposing a time delay in an electronic circuit before allowing treats to be retrieved.

29. The method of claim 24, wherein the step of allowing actuation of the device comprises providing a device depressible by a user.

30. The method of claim 24, wherein the step of allowing actuation of the device comprises providing a device rotatable by a user.

31. A dispensing device comprising:
a housing;
a dispenser within said housing, said dispenser moveable from a first position to a second position to sequentially release treats contained in said housing;
actuating means for actuating said dispenser to move said dispenser incrementally from said first position to said second position;
a time delay imposed between actuating the dispenser and sequentially releasing treats; and
an area for allowing treats to be retrieved.

32. The dispensing device of claim 1, wherein the dispenser includes a first arm and a second arm connected to the first arm, said first arm sized to contact said dispenser.

33. The dispensing device of claim 32, wherein said actuating means includes an upper sprocket, a lower sprocket, and a chain connecting said lower sprocket to said upper sprocket.

34. The dispensing device of claim 33, further comprising a projection member attached to said chain, said projection member sized to contact said first arm of said dispenser and to move said first arm in a vertical direction.

35. The dispensing device of claim 34, wherein the reservoir includes a spring sized to urge treats received in the reservoir in a vertical direction.

36. The dispensing device of claim 35, further comprising a plunger connected to said second arm of said dispenser, said plunger sized to move in a horizontal direction when said projection member moves said first arm in a vertical direction.

37. The dispensing device of claim 36, wherein said receptacle is located between said actuating means and said reservoir.
